(19) United States
(12) Patent Application Publication
(10) Pub. No.: US 2025/0289972 A1
(43) Pub. Date: Sep. 18, 2025

(54) INK SET FOR THERMAL TRANSFER SHEET AND METHOD FOR PRODUCING THERMAL TRANSFER SHEET

(71) Applicant: RISO KAGAKU CORPORATION, Tokyo (JP)

(72) Inventor: Akiko HAYASHI, Tokyo (JP)

(21) Appl. No.: 19/060,417

(22) Filed: Feb. 21, 2025

(30) Foreign Application Priority Data
Mar. 13, 2024 (JP) 2024-039173
Nov. 28, 2024 (JP) 2024-207000

(51) Int. Cl. C09D 11/54; B41M 5/025; C09D 11/322; C09D 11/40

(52) U.S. Cl. CPC C09D 11/54; B41M 5/0256; C09D 11/322; C09D 11/40

(57) ABSTRACT

Provided is an ink set for a thermal transfer sheet including: a color ink having a color other than white; at least one selected from the group consisting of a white ink and a transparent ink; and an ink aggregation liquid.

### CROSS REFERENCE TO RELATED APPLICATIONS

This application is based upon and claims the benefit of priority from the prior Japanese Patent Application No. 2024-039173, filed on Mar. 13, 2024, and the prior Japanese Patent Application No. 2024-207000, filed on Nov. 28, 2024, the entire contents of which are incorporated by reference herein.

### BACKGROUND OF THE INVENTION

### Field of the Invention

Embodiments of the present invention relate to an ink set for a thermal transfer sheet and a method for producing a thermal transfer sheet.

### Description of the Related Art

In recent years, DTF printing is attracting attention as a method for performing printing of images such as letters, pictures, and designs on fabrics such as woven fabrics, knitted fabrics, and nonwoven fabrics. DTF is an abbreviation of Direct To Film and is specifically a printing method using a thermal transfer sheet. A thermal transfer sheet for DTF printing is generally produced by means of a method in which after a desired image is color printed on a substrate sheet, a white ink is printed on the image, hot melt powder is adhered on the white ink which is not dried yet, and the hot melt powder is melted by heating. Printing on fabric is performed by arranging a hot melt powder layer of a thermal transfer sheet on the fabric side and transferring an image by a thermal press. Compared to a method for direct printing on fabric, DTF printing has advantages such as higher image clarity and a wide range of choices in types and colors of fabric on which printing is possible.

As a prior art related to DTF printing, JP 2019-171840 A discloses an example of using resin powder with heat-melting properties and a grade in which the resin powder adheres to an entire surface of an ink without gaps, and a transfer sheet that has enough ink impermeability to maintain the adhesiveness of the resin powder. Specifically, the grade of the resin powder is defined that percentage of the resin powder with a particle size of 75 μm or less occupied is 87% and powder with a particle size of more than 150 μm is not included.

### BRIEF SUMMARY OF THE INVENTION

One of technical objects of DTF printing is to ensure the adhesiveness of hot melt powder. In the method disclosed in JP 2019-171840 A, a substrate sheet having high impermeability is used to ensure the adhesiveness of hot melt powder. However, when a thermal transfer sheet is produced by means of this method, there are other problems that color mixing between a color ink forming an image and a white ink applied thereon is likely to occur, and image reproduction characteristics easily deteriorate.

One embodiment of the present invention relates to an ink set for a thermal transfer sheet including: a color ink having a color other than white; at least one selected from the group consisting of a white ink and a transparent ink; and an ink aggregation liquid.

Another embodiment of the present disclosure relates to a method for producing a thermal transfer sheet comprising: applying a color ink having a color other than white, an ink aggregation liquid, and at least one selected from the group consisting of a white ink and a transparent ink on a substrate sheet in order by a wet-on-wet method.

Another embodiment of the present disclosure relates to a method for producing a thermal transfer sheet comprising: applying an ink aggregation liquid, a color ink having a color other than white, and at least one selected from the group consisting of a white ink and a transparent ink on a substrate sheet in order by a wet-on-wet method.

### DETAILED DESCRIPTION OF THE INVENTION

Embodiments of the present disclosure will be described below in detail, but the present disclosure is not limited to these embodiments, and various modifications and alterations are possible.

An ink set for a thermal transfer sheet (hereinafter sometimes referred to as “ink set”) of an embodiment includes a color ink having a color other than white (hereinafter sometimes referred to as “non-white color ink”), at least one selected from the group consisting of a white ink and a transparent ink (hereinafter sometimes referred to as “white/transparent ink”), and an ink aggregation liquid. In an embodiment, by using the ink aggregation liquid for producing the thermal transfer sheet, the thickness of the white/transparent ink is stabilized. This enables acquisition of a thermal transfer sheet with excellent image reproduction characteristics and suppression of image defect. Further, even when the amount of the white/transparent ink applied is relatively large, dripping is less likely to occur. Therefore, it is possible to design to apply a large amount of the white/transparent ink. This can enhance the transferability to a print medium and suppress the image defect. Still further, a transfer sheet with excellent image reproduction characteristics can be obtained due to an effect of suppressing color mixing between the non-white color ink and the white/transparent ink. In particular, when inkjet printing is used for image printing, inkjet inks often contain low volatile fraction solvents to prevent clogging of a nozzle during a period when a printer is not in use. In this case, the inks containing the low volatile fraction solvents are easily mixed on a substrate sheet, and color mixing is likely to occur. Even when the non-white color ink, the white ink, and the transparent ink of the ink set of an embodiment are inkjet inks, it is possible to obtain a thermal transfer sheet with excellent image reproduction characteristics due to an action of the ink aggregation liquid.

Further, in another embodiment, by using the ink aggregation liquid for producing the thermal transfer sheet, even when powder such as hot melt powder is used as an adhesiveness imparting agent during transfer, the hot melt powder adhesiveness of the white/transparent ink is ensured, prevent the color mixing between the non-white color ink and the white/transparent ink, and enables acquisition of a thermal transfer sheet with excellent image reproduction characteristics. When the powder such as the hot melt powder is used as the adhesiveness imparting agent during transfer, by using the ink aggregation liquid for producing the thermal transfer sheet, it is possible to suppress the fluidity of the white/transparent ink before applying the powder. As a result, especially when a white ink is used, it is possible to obtain a thermal transfer sheet of a white solid image with excellent uniformity. If the powder is applied in a state where the fluidity of the white/transparent ink is high, the powder absorbs too much white/transparent ink. As a result, especially when a white ink is used, irregularities occur in a white solid image, and therefore the uniformity of the white solid image deteriorates.

The ink set of an embodiment will be described below. The ink set of an embodiment includes the color ink having a color other than white (non-white color ink). The non-white color ink refers to a color ink having a color other than white, such as a cyan ink, a magenta ink, a yellow ink, and a black ink. The type of the non-white color ink is not particularly limited, and various types of inks can be used. As an example, the non-white color ink may be an aqueous inkjet ink. Further, a single non-white color ink may be used alone, or a combination of two or more non-white color inks may be used.

The non-white color ink includes a non-white colorant. A single colorant may be used alone, or a combination of two or more colorants may be used. An example of the colorant is various non-white pigments. Pigments which can be used include organic pigments such as azo pigments, phthalocyanine pigments, polycyclic pigments, and dye lake pigments, and inorganic pigments such as carbon blacks and metal oxides. Examples of azo pigments include soluble azo lake pigments, insoluble azo pigments, and condensed azo pigments. Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black.

When the non-white color ink is an inkjet ink, from the viewpoints of the jetting stability and the storage stability of the ink, the average particle size of pigment particles, expressed as the volume-based average value in a particle size distribution measured by a dynamic light scattering method, may be 300 nm or less, 200 nm or less, or 150 nm or less.

The non-white pigments may be self-dispersing pigments or microencapsulated pigments in which the pigments have been coated with resins. Further, for the non-white color ink, a pigment dispersion containing pigments that have already been dispersed using a pigment dispersant may be used, or pigments dispersed using a pigment dispersant which will be described later may be used.

The self-dispersing pigment is a pigment in which a hydrophilic functional group has been introduced into the surface of the pigment by a chemical treatment or physical treatment. The hydrophilic functional group to be introduced into the self-dispersing pigment is preferably ionic, and the pigment particles can be stably dispersed in water by an electrostatic repulsion force by anionically or cationically charging the surface of the pigment. Examples of anionic functional groups include carboxyl groups, sulfo groups, sulfino groups, sulfuric acid ester groups, phosphoric acid groups, phosphoric acid ester groups, phosphorous acid groups, and phosphorous acid ester groups. Examples of cationic functional groups include quaternary ammonium groups and quaternary phosphonium groups. These hydrophilic functional groups may be bonded directly to the pigment surface or bonded via other atom groups. Examples of other atom groups include alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

Examples of products that can be used favorably as self-dispersing pigments include the “CAB-O-JET” series of products such as (“CAB-O-JET 200”, “CAB-O-JET 300”, “CAB-O-JET 250C”, “CAB-O-JET 260M”, “CAB-O-JET 270Y”, “CAB-O-JET 450C”, and “CAB-O-JET 465M”) manufactured by Cabot Corporation, and “BONJET” series of products such as (“BONJET BLACK CW-1”, “BONJET BLACK CW-2”, “BONJET BLACK CW-3”, and “BONJET BLACK CW-4”) manufactured by Orient Chemical Industries, Ltd.

Examples of commercially available products of pigment dispersions containing pigments that have already been dispersed using a pigment dispersant include HOSTAJET series of products manufactured by Clariant AG, and FUJI SP series of products manufactured by Fuji Pigment Co., Ltd.

The amount of the non-white pigments in the non-white color ink is not particularly limited, and it is possible to use non-white pigments in the same amount range as those in a general non-white color ink. The amount of the non-white pigments may be in a range from 1 to 10% by mass, relative to the total amount of the non-white color ink, for example.

Various pigment dispersants may be used to stably disperse the non-white pigments in the non-white color ink. A single pigment dispersant may be used alone, or a combination of two or more pigment dispersants may be used. Examples of the pigment dispersants include polymer dispersants, surfactant-type dispersants, and the like.

Examples of commercially available polymer dispersants include the TEGO Dispers series of products manufactured by Evonik Industries AG (including “TEGO Dispers 740W”, “TEGO Dispers 750W”, “TEGO Dispers 755W”, “TEGO Dispers 757W”, and “TEGO Dispers 760W”), the Solsperse series of products manufactured by The Lubrizol Corporation (including “Solsperse 20000”, “Solsperse 27000”, “Solsperse 41000”, “Solsperse 41090”, “Solsperse 43000”, “Solsperse 44000”, and “Solsperse 46000”), the Joncryl series of products manufactured by BASF Japan Ltd. (including “Joncryl 57”, “Joncryl 60”, “Joncryl 62”, “Joncryl 63”, “Joncryl 71”, and “Joncryl 501”), as well as “DISPERBYK-102”, “DISPERBYK-185”, “DISPERBYK-190”, “DISPERBYK-193”, and “DISPERBYK-199” manufactured by BYK-Chemie Japan K.K., and “Polyvinylpyrrolidone K-30” and “Polyvinylpyrrolidone K-90” manufactured by DKS Co. Ltd. (all of the above are product names).

Examples of commercially available surfactant-type dispersants include anionic surfactants, including the DEMOL series of products such as (“DEMOL P”, “DEMOL EP”, “DEMOL N”, “DEMOL RN”, “DEMOL NL”, “DEMOL RNL”, and “DEMOL T-45”) manufactured by Kao Corporation, and nonionic surfactants including the EMULGEN series of products such as (“EMULGEN A-60”, “EMULGEN A-90”, “EMULGEN A-500”, “EMULGEN B-40”, “EMULGEN L-40”, and “EMULGEN 420”) manufactured by Kao Corporation (all of the above are product names).

The amount of a pigment dispersant that may be used in the non-white color ink is appropriately adjusted according to types of the non-white pigments and the pigment dispersant. The amount may be in a range from 0.5 to 150 parts by mass, relative to 100 parts by mass of the non-white pigments.

The non-white color ink preferably contains a resin. A single resin may be used alone, or a combination of two or more resins may be used. The amount of the resin in the non-white color ink is appropriately adjusted according to the desired viscosity or the like, but may be in a range from 3 to 30% by mass, for example.

As a type of resin, a resin which can form a transparent coating film is preferable to achieve a non-white color ink with excellent color development properties. Specific examples of the resin include conjugated diene resins such as styrene-butadiene copolymers, methyl methacrylate-butadiene copolymers, and vinyl chloride-vinyl acetate copolymers; acrylic-based resins such as polymers of acrylic acid esters and methacrylic acid esters, or copolymers thereof with styrene or the like; vinyl-based resins such as ethylene-vinyl acetate copolymers, or functional-group modified resins based on monomers containing functional groups such as carboxyl groups of these various resins; melamine resins; urea resins; polyurethane resins; polyester resins; polyolefin resins; silicone resins; polyvinyl butyral resins; and alkyd resins.

When the non-white color ink is aqueous, the resin is preferably resin particles that can be dispersed in an aqueous solvent such as water or a water-soluble organic solvent. In particular, it is preferable that the resin can form an oil-in-water (O/W) type emulsion without being dissolved in the water. The resin may be blended into the ink in the form of an aqueous dispersion of the resin particles, when the non-white color ink is produced.

When the resin is resin particles that can be dispersed in an aqueous solvent, the resin may be a resin in which functional groups of the resin are located on the resin particle surfaces, as in the case of a self-emulsifying resin, or may be a resin that has been subjected to a surface treatment by, for example, adhering a dispersant to the resin particle surfaces. The resin particles may be anionic, cationic, nonionic, or amphoteric, for example, but are preferably anionic or nonionic.

The anionic resin particles may be a resin in which anionic functional groups of the resin are located on the resin particle surfaces, as in the case of a self-emulsifying resin, or may be a resin that has been subjected to a surface treatment by, for example, adhering an anionic dispersant to the resin particle surfaces. Examples of typical anionic functional groups include carboxyl groups, sulfo groups, sulfino groups, sulfuric acid ester groups, phosphoric acid groups, phosphoric acid ester groups, phosphorous acid groups, phosphorous acid ester groups, and the like. Examples of anionic dispersants include anion surfactants and the like.

Examples of commercially available products of aqueous dispersions of resin particles include polyurethane dispersion “DAOTAN” series of products such as (“DAOTAN TW6450”, “DAOTAN TW6460”, “DAOTAN TW6490”, and “DAOTAN VTW1262”) manufactured by DAICEL-ALLNEX LTD., the “Impranil” series of products such as (“Impranil DLP”, “Impranil DLP-R”, “Impranil DLV”, “Impranil DLI”, “Impranil 1016”, “Impranil 1116”, “Impranil DLS”, “Impranil DL 1537”, “Impranil DL 1554”, “Impranil DL 1380”, “Impranil LP CGL 105”, “Impranil DLN-SD”, “Impranil LP DSB 1069”, and “Impranil DLN-W50”) manufactured by Sumika Covestro Urethane Company, Ltd., the “SUPERFLEX” series of products such as (“SUPERFLEX 420”, “SUPERFLEX 150HS”, “SUPERFLEX 460”, “SUPERFLEX 470”, “SUPERFLEX E2000”, “SUPERFLEX 740”, “SUPERFLEX 500M”, and “SUPERFLEX 300”) manufactured by DKS Co., Ltd., the “Elitel” series of products such as (“Elitel KT 9204” and “Elitel KT 8803”) manufactured by UNITIKA LTD., the “NeoRez” series of products such as (“NeoRez R-966” and “NeoRez R-4000”) manufactured by DSM, and the “AQUACER” series of products such as (“AQUACER 507”) manufactured by BYK, and the “Mowinyl” series of products such as (“Mowinyl 6750”, “Mowinyl 6751D”, “Mowinyl 6763”, “Mowinyl 6770”, and “Mowinyl 6775”) manufactured by Japan Coating Resin Corporation.

The non-white color ink may contain other components other than the non-white pigments and resin. Examples of other components include an organic solvent, water, a surfactant, a pH adjuster, a dispersant, a fixing agent, a preservative, and the like.

The type of the organic solvent is not particularly limited, and an organic solvent generally used in the ink field can be widely used. The amount of the organic solvent in the non-white color ink may be 1% by mass or more, 5% by mass or more, or 10% by mass or more, for example. Further, the amount of the organic solvent in the non-white color ink may be 60% by mass or less, 50% by mass or less, or 40% by mass or less. The amount of the organic solvent in the non-white color ink may be in a range from 1 to 60% by mass, for example.

It is preferable that the non-white color ink contains an organic solvent having a boiling point of 260° C. or higher (hereinafter sometimes referred to as “high boiling point solvent”) among organic solvents. When at least one of inks of the ink set includes the high boiling point solvent, the powder adhesiveness is enhanced. In addition, when the non-white color ink is an inkjet ink, due to the non-white color ink including the high boiling point solvent, the nozzle clogging is even less likely to occur during a period when a printer is not in use. In the ink set for a thermal transfer sheet of an embodiment, even when the non-white color ink includes the high boiling point solvent, the fluidity of the white/transparent ink is decreased by an action of the ink aggregation liquid before the powder is applied. This suppresses deterioration in the uniformity of a white solid image caused by the powder absorbing too much ink, and enables acquisition of a thermal transfer sheet with excellent image reproduction characteristics.

The boiling point of the high boiling point organic solvent may be 270° C. or higher, or 280° C. or higher. Further, the boiling point of the high boiling point organic solvent may be 350° C. or lower, 320° C. or lower, or 300° C. or lower. The boiling point of the high boiling point organic solvent may be in a range from 260 to 350° C., for example.

The amount of the high boiling point organic solvent in the non-white color ink may be 1% by mass or more, 3% by mass or more, or 5% by mass or more, for example. Further, the amount of the high boiling point organic solvent in the non-white color ink may be 40% by mass or less, 30% by mass or less, or 20% by mass or less. The amount of the high boiling point organic solvent in the non-white color ink may be in a range from 1 to 40% by mass, for example.

The ratio of the high boiling point organic solvent to the total organic solvent in the non-white color ink may be 5% by mass or more, 10% by mass or more, or 20% by mass or more, for example. Further, the ratio of the high boiling point organic solvent to the total organic solvent in the non-white color ink may be 60% by mass or less, 50% by mass or less, or 40% by mass or less. The ratio of the high boiling point organic solvent to the total organic solvent in the non-white color ink may be in a range from 5 to 60% by mass, for example.

In an embodiment, when the non-white color ink is aqueous, a water-soluble organic solvent can preferably be used as the organic solvent. As the water-soluble organic solvent, a water-soluble organic solvent generally used in the field of an aqueous ink can be used without any particular limitation. A single water-soluble organic solvent may be used alone, or a combination of two or more water-soluble organic solvents may be used. In particular, it is preferable to use a water-soluble organic solvent that is liquid at room temperature and mixes uniformly with an equal volume of water at 1 atmosphere and 20° C. Examples of this kind of water-soluble organic solvent that may be used include lower alcohol compounds such as methanol, ethanol, 1-propanol, isopropanol, 1-butanol, 2-butanol, isobutanol, and 2-methyl-2-propanol; glycol compounds such as ethylene glycol, diethylene glycol, trimethylene glycol, triethylene glycol, tetraethylene glycol, propylene glycol, dipropylene glycol, and tripropylene glycol; glycerol compounds such as glycerol, diglycerol, and triglycerol; acetin compounds such as monoacetin, diacetin, and triacetin; glycol ether compounds such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, 1-methyl-2-pyrrolidone, 1,3-dimethyl-2-imidazolidinone, β-thiodiglycol, and sulfolane.

Among the water-soluble organic solvents, examples of a water-soluble high boiling point organic solvent corresponding to the above-described high boiling point organic solvent include triethylene glycol, tetraethylene glycol, and tripropylene glycol among glycol solvents; and glycerol, diglycerol, and triglycerol among glycerol solvents.

When the non-white color ink is aqueous, it is preferable that the non-white color ink contains the water-soluble organic solvent. The amount of the water-soluble organic solvent in the non-white color ink may be 1% by mass or more, 5% by mass or more, or 10% by mass or more, for example. Further, the amount of the water-soluble organic solvent in the non-white color ink may be 60% by mass or less, 50% by mass or less, or 40% by mass or less. The amount of the water-soluble organic solvent in the non-white color ink may be in a range from 1 to 60% by mass, for example.

The amount of the water-soluble high boiling point organic solvent in the non-white color ink may be 1% by mass or more, 3% by mass or more, or 5% by mass or more, for example. Further, the amount of the water-soluble high boiling point organic solvent in the non-white color ink may be 40% by mass or less, 30% by mass or less, or 20% by mass or less. The amount of the water-soluble high boiling point organic solvent in the non-white color ink may be in a range from 1 to 40% by mass, for example.

The ratio of the water-soluble high boiling point organic solvent to the total water-soluble organic solvent in the non-white color ink may be 5% by mass or more, 10% by mass or more, or 20% by mass or more, for example. Further, the ratio of the water-soluble high boiling point organic solvent to the total water-soluble organic solvent in the non-white color ink may be 100% by mass, 60% by mass or less, 50% by mass or less, or 40% by mass or less. The ratio of the water-soluble high boiling point organic solvent to the total water-soluble organic solvent in the non-white color ink may be in a range from 5 to 100% by mass, for example.

The non-white color ink may be aqueous. If the non-white color ink is an aqueous ink, examples of water contained in the non-white color ink include ion-exchanged water, distilled water, ultrapure water, and the like. The ratio of the water to the total amount of the non-white color ink may be appropriately adjusted according to the desired viscosity, but may be in a range from 30 to 90% by mass, for example.

Examples of the surfactant that may be used include an anionic surfactant, a cationic surfactant, an amphoteric surfactant, and a nonionic surfactant. The surfactant may be either a low-molecular-weight surfactant or a polymer-based surfactant. A single surfactant may be used alone, or a combination of two or more surfactants may be used. From thereamong, the nonionic surfactant is preferable. An HLB value of the surfactant is preferably in a range from 5 to 20, and more preferably in a range from 10 to 18.

Examples of the nonionic surfactant include ester-based surfactants such as glycerol fatty acid esters and fatty acid sorbitan esters; ether-based surfactants such as polyoxyethylene alkyl ethers, polyoxyethylene alkylphenyl ethers, and polyoxypropylene alkyl ethers; ether ester-based surfactants such as polyoxyethylene sorbitan fatty acid esters; acetylene-based surfactants; silicone-based surfactants; and fluorine-based surfactants. Among these, acetylene-based surfactants can be used particularly favorably.

Examples of the acetylene-based surfactants include acetylene glycol-based surfactants, acetylene alcohol-based surfactants, and surfactants having an acetylene group.

Acetylene glycol-based surfactants are glycols having an acetylene group, are preferably glycols having a left-right symmetrical structure with an acetylene group in the center, and may include a structure in which ethylene oxide has been added to acetylene glycol. Examples of commercially available products of acetylene-based surfactants include the SURFYNOL series of products such as (“SURFYNOL 104E”, “SURFYNOL 104H”, “SURFYNOL 420”, “SURFYNOL 440”, “SURFYNOL 465”, and “SURFYNOL 485”) manufactured by Evonik Industries AG, and the OLFINEE series of products such as (“OLFINEE E1004”, “OLFINEE E1010”, and “OLFINEE E1020”) manufactured by Nissin Chemical Industry Co., Ltd.

Examples of the silicone-based surfactants include polyether-modified silicone-based surfactants, alkyl-aralkyl-comodified silicone-based surfactants, and acrylic silicone-based surfactants. Examples of commercially available products of silicone-based surfactants include “SILFACE SAG002” and “SILFACE SAG503A” manufactured by Nissin Chemical Industry Co., Ltd. (both of the above are product names).

Further examples of other nonionic surfactants include polyoxyethylene alkyl ether-based surfactants such as the EMULGEN series of products including (“EMULGEN 102 KG”, “EMULGEN 103”, “EMULGEN 104P”, “EMULGEN 105”, “EMULGEN 106”, “EMULGEN 108”, “EMULGEN 120”, “EMULGEN 147”, “EMULGEN 150”, “EMULGEN 220”, “EMULGEN 350”, “EMULGEN 404”, “EMULGEN 420”, “EMULGEN 705”, “EMULGEN 707”, “EMULGEN 709”, “EMULGEN 1108”, “EMULGEN 4085”, and “EMULGEN 2025G”) manufactured by Kao Corporation (all of the above are product names).

It is preferable that the non-white color ink contains the surfactant. The amount of the surfactant in the non-white color ink may be in a range from 0.01 to 10% by mass, relative to the total amount of the non-white color ink, for example.

There are no particular limitations on a method used for producing the non-white color ink, and the non-white color ink can be produced by means of a method for producing a general non-white color ink. As an example, the non-white color ink may be obtained by using a stirring device such as a three-one motor to disperse all of components, either in a single batch or in a number of separate batches, and then passing the resulting dispersion through a filtration device such as a membrane filter if desired.

From the viewpoint of ink storage stability, the pH of the non-white color ink may be in a range from 7.0 to 10.0, for example. Further, when the non-white color ink is an inkjet ink, from the viewpoint of inkjet jetting properties, the viscosity thereof at 23° C. may be in a range from 1 to 30 mPa·s, for example.

The ink set of an embodiment includes at least one selected from the group consisting of the white ink and the transparent ink. The type of the white ink included in the ink set is not particularly limited, and a wide variety of inks can be used for the white ink. As an example, the white ink may be an aqueous inkjet ink.

The white ink contains a white colorant. A single colorant may be used alone, or a combination of two or more colorants may be used. Examples of the colorant include various white pigments, such as white inorganic pigments including titanium oxide, zinc oxide, zinc sulfide, antimony oxide, or zirconium oxide. From thereamong, it is preferable to use titanium oxide, from the viewpoint of concealment properties. The average particle size of titanium oxide is not particularly limited, but may be in a range from 100 to 600 nm, for example. In the white ink, a pigment dispersion in which pigments have been dispersed in advance with a pigment dispersant may be used, or pigment dispersions that have been dispersed with a pigment dispersant described below may be used.

The amount of white pigments in the white ink is not particularly limited, and it is possible to use white pigments in the same amount range as those in a general white ink. The amount of the white pigments may be 1% by mass or more, 3% by mass or more, or 5% by mass or more, relative to the total amount of the white ink, for example. Further, the amount of the white pigments may be 30% by mass or less, 20% by mass or less, or 15% by mass or less. The amount of the white pigments may be in a range from 1 to 30% by mass, relative to the total amount of the white ink, for example.

In order to stably disperse the white pigments in the white ink, various kinds of pigment dispersants may be used. A single pigment dispersant may be used alone, or a combination of two or more pigment dispersants may be used. Examples of the pigment dispersant include those exemplified as the pigment dispersants that can be contained in the non-white color ink, for example.

The blending amount of a pigment dispersant that may be used in the white ink is appropriately adjusted according to types of the white pigments and the pigment dispersant. The amount may be in a range from 0.5 to 50 parts by mass, relative to 100 parts by mass of the pigments, for example.

The white ink preferably contains a resin. A single resin may be used alone, or a combination of two or more resins may be used. The amount of the resin in the white ink is appropriately adjusted according to the desired viscosity, or the like, but may be in a range from 3 to 30% by mass, for example.

As a type of resin, a resin which can form a transparent coating film is preferable to achieve a white ink with excellent color development properties. Specific examples of the resin include those exemplified as the resins that can be included in the non-white color ink, for example.

The white ink may contain other components other than the white pigments and resin. Examples of other components contains an organic solvent, water, a surfactant, a pH adjuster, a dispersant, a fixing agent, a preservative, and the like.

The type of the organic solvent is not particularly limited, and an organic solvent generally used in the ink field can be widely used. The amount of the organic solvent in the white ink may be 1% by mass or more, 5% by mass or more, or 10% by mass or more, for example. Further, the amount of the organic solvent in the white ink may be 50% by mass or less, 40% by mass or less, or 30% by mass or less. The amount of the water-soluble organic solvent in the white ink may be in a range from 1 to 50% by mass, for example.

It is preferable that the white ink contains s an organic solvent having a boiling point of 260° C. or higher (high boiling point organic solvent) among organic solvents. When at least one of inks of the ink set contains the high boiling point organic solvent, the powder adhesiveness is enhanced. In addition, when the white ink is an inkjet ink, due to the white ink including the high boiling point organic solvent, the nozzle clogging is even less likely to occur during a period when a printer is not in use. In the ink set for a thermal transfer sheet of an embodiment, even when the white ink contains the high boiling point solvent, it is possible to obtain a thermal transfer sheet with excellent image reproduction characteristics by an action of the ink aggregation liquid.

The amount of the high boiling point organic solvent in the white ink may be 1% by mass or more, 5% by mass or more, or 10% by mass or more, for example. Further, the amount of the high boiling point organic solvent in the white ink may be 50% by mass or less, 40% by mass or less, or 30% by mass or less. The amount of the high boiling point organic solvent in the white ink may be in a range from 1 to 40% by mass, for example.

The ratio of the high boiling point organic solvent to the total organic solvent in the white ink may be 10% by mass or more, 50% by mass or more, 70% by mass or more, 90% by mass or more, or 100% by mass, for example. The ratio of the high boiling point organic solvent to the total organic solvent in the white ink may be in a range from 10 to 100% by mass, for example.

In an embodiment, when the white ink is aqueous, a water-soluble organic solvent can preferably be used as the organic solvent. Specific examples of the water-soluble organic solvent contained in the white ink include those exemplified as the water-soluble organic solvents that can be contained in the non-white color ink. A single water-soluble organic solvent may be used alone, or a combination of two or more water-soluble organic solvents may be used.

When the white ink is aqueous, it is preferable that the white ink contains the water-soluble organic solvent. The amount of the water-soluble organic solvent in the white ink may be 1% by mass or more, 5% by mass or more, or 10% by mass or more, for example. Further, the amount of the water-soluble organic solvent in the white ink may be 50% by mass or less, 40% by mass or less, or 30% by mass or less. The amount of the water-soluble organic solvent in the white ink may be in a range from 1 to 50% by mass, for example.

The amount of the water-soluble high boiling point organic solvent in the white ink may be 1% by mass or more, 5% by mass or more, or 10% by mass or more, for example. Further, the amount of the water-soluble high boiling point organic solvent in the white ink may be 50% by mass or less, 40% by mass or less, or 30% by mass or less. The amount of the water-soluble high boiling point organic solvent in the white ink may be in a range from 1 to 40% by mass, for example.

The ratio of the water-soluble high boiling point organic solvent to the total water-soluble organic solvent in the white ink may be 30% by mass or more, 50% by mass or more, 70% by mass or more, or 100% by mass, for example. The ratio of the water-soluble high boiling point organic solvent to the total water-soluble organic solvent in the white ink may be in a range from 30 to 100% by mass, for example.

The white ink may be aqueous. If the white ink is an aqueous ink, examples of water contained in the white ink include ion-exchanged water, distilled water, ultrapure water, and the like. The ratio of the water to the total amount of the white ink may be appropriately adjusted according to the desired viscosity, but may be in a range from 30 to 90% by mass, for example.

It is preferable that the white ink contains a surfactant. Specific examples of the surfactant contained in the white ink include those exemplified as the surfactants that can be contained in the non-white color ink. The amount of the surfactant in the white ink may be in a range from 0.01 to 10% by mass, relative to the total amount of the non-white color ink, for example.

There are no particular limitations on a method used for producing the white ink, and the white ink can be produced by means of a method for producing a general white ink. As an example, the white ink may be obtained by using a stirring device such as a three-one motor to disperse all of components, either in a single batch or in a number of separate batches, and then passing the resulting dispersion through a filtration device such as a membrane filter if desired.

From the viewpoint of ink storage stability, the pH of the white ink may be in a range from 7.0 to 10.0, for example. Further, when the white ink is an inkjet ink, from the viewpoint of inkjet jetting properties, the viscosity thereof at 23° C. may be in a range from 1 to 30 mPa·s, for example.

The type of the transparent ink that can be included in the ink set of an embodiment is not particularly limited, and a wide variety of inks can be used for the transparent ink. As an example, the transparent ink may be an aqueous inkjet ink.

The transparent ink may not contain a colorant or may contain a colorant to the extent that image reproduction characteristics are not degraded. The amount of the colorant contained in the transparent ink may be 0.1% by mass or less, for example. The transparent ink preferably contains a resin which can form a transparent coating film. Specific examples of the resin include those exemplified as the resin that can be contained in the non-white color ink, for example.

The transparent ink may contain other components other than the resin. Examples of other components contain an organic solvent, water, a surfactant, a pH adjuster, a dispersant, a fixing agent, a preservative, and the like.

The type of the organic solvent is not particularly limited, and an organic solvent generally used in the ink field can be widely used. When at least one of inks of the ink set contains a high boiling point organic solvent, the powder adhesiveness is enhanced. In addition, when the transparent ink is an inkjet ink, due to the transparent ink including the high boiling point organic solvent, the nozzle clogging is even less likely to occur during a period when a printer is not in use. In the ink set for a thermal transfer sheet of an embodiment, even when the transparent ink contains the high boiling point solvent, it is possible to obtain a thermal transfer sheet with excellent image reproduction characteristics by an action of the ink aggregation liquid.

In an embodiment, when the transparent ink is aqueous, a water-soluble organic solvent can preferably be used as the organic solvent. Specific examples of the water-soluble organic solvent contained in the transparent ink include those exemplified as the water-soluble organic solvents that can be contained in the non-white color ink. A single water-soluble organic solvent may be used alone, or a combination of two or more water-soluble organic solvents may be used.

The transparent ink may be aqueous. If the transparent ink is an aqueous ink, examples of water contained in the transparent ink include ion-exchanged water, distilled water, ultrapure water, and the like. The ratio of the water to the total amount of the transparent ink may be appropriately adjusted according to the desired viscosity, but may be in a range from 30 to 90% by mass, for example.

The ink set of an embodiment includes at least one selected from the group consisting of the white ink and the transparent ink. The ink set may include both of the white ink and the transparent ink. As an example, when a print medium has a low-brightness color such as black or navy blue, image formation with excellent color reproducibility is possible. Therefore, it is preferable that the ink set includes at least the white ink. Meanwhile, when a print medium has a high-brightness color such as white, and transparent printing is performed on a part of an image to make a color of a print medium transparent, the ink set may include either the white ink or the transparent ink, or both of the white ink and the transparent ink.

The ink set of an embodiment includes the ink aggregation liquid. Specifically, the ink aggregation liquid contains an ink aggregating agent. Examples of the ink aggregating agent include metal salts, cationic polymers, organic acids, and the like.

The metal salts are composed of metal ions and anions, for example. Examples of the metal ions include monovalent metal ions such as Na⁺ and K⁺; and polyvalent metal ions such as Ca²⁺, Mg²⁺, Cu²⁺, Ni²⁺, Zn²⁺, and Ba²⁺. Examples of the anions include Cl⁻, NO₃⁻, CH₃COO⁻, I⁻, Br⁻, and ClO₃⁻. A single metal salt may be used alone, or a combination of two or more metal salts may be used.

Examples of the cationic polymers include polyallylamine, polyallylamine sulfate, polyallylamine hydrochloride, allylamine-diallylamine copolymer, allylamine-diallylamine copolymer sulfate, allylamine-diallylamine copolymer hydrochloride, allylamine-dimethylallylamine copolymer, allylamine-dimethylallylamine copolymer sulfate, allylamine-dimethylallylamine copolymer hydrochloride, diallylamine, diallylamine sulfate, diallylamine hydrochloride, methyl diallylamine amide, methyl diallylamine amide sulfate, methyl diallylamine amide hydrochloride, diallylamine sulfur dioxide copolymer, diallylamine sulfur dioxide copolymer sulfate, diallylamine sulfur dioxide copolymer hydrochloride, methyldiallylamine sulfur dioxide copolymer, methyldiallylamine sulfur dioxide copolymer sulfate, methyldiallylamine sulfur dioxide copolymer hydrochloride, and polydimethyldiallylammonium chloride. A single cationic polymer may be used alone, or a combination of two or more cationic polymers may be used.

Examples of the organic acids include formic acids, acetic acids, lactic acids, oxalic acids, citric acids, malic acids, ascorbic acids, and the like. A single organic acid may be used alone, or a combination of two or more organic acids may be used.

In particular, since a thermal transfer sheet with excellent image reproduction characteristics can be obtained, the ink aggregation liquid preferably contains a metal salt, and more preferably contains a polyvalent metal salt formed of a polyvalent metal ion and an anion. Examples of the polyvalent metal salt include divalent metal salts such as calcium salt and magnesium salt.

The ratio of the metal salt to the ink aggregating agent contained in the ink aggregation liquid is preferably 50% by mass or more, more preferably 70% by mass or more, and even more preferably 90% by mass or more. In addition, the ratio of the metal salt to the ink aggregating agent may be 100% by mass. Further, the ratio of the polyvalent metal salt to the ink aggregating agent is preferably 50% by mass or more, more preferably 70% by mass or more, and even more preferably 90% by mass or more. In addition, the ratio of the polyvalent metal salt to the ink aggregating agent may be 100% by mass.

The amount of the ink aggregating agent in the ink aggregation liquid is appropriately adjusted according to the type of the ink aggregating agent. As an example, the amount of the ink aggregating agent in the ink aggregation liquid may be 1% by mass or more, 10% by mass or more, or 20% by mass or more. In addition, the amount of the ink aggregating agent in the ink aggregation liquid may be 50% by mass or less, 45% by mass or less, or 40% by mass or less. The amount of the ink aggregating agent in the ink aggregation liquid may be in a range from 1 to 50% by mass, for example.

When the ink aggregation liquid contains a metal salt, the concentration of the metal salt in the ink aggregation liquid may be 0.1 mol/kg or more, 0.3 mol/kg or more, or 0.5 mol/kg or more. Further, the concentration of the metal salt in the ink aggregation liquid may be 10 mol/kg or less, 5 mol/kg or less, or 2 mol/kg or less. The concentration of the metal salt in the ink aggregation liquid may be in a range from 0.1 to 10 mol/kg, for example.

The ink aggregation liquid may contain other components in addition to the ink aggregating agent. Examples of other components include an organic solvent, water, a surfactant, a pH adjuster, a dispersant, a fixing agent, a preservative, and the like.

In an embodiment, when inks of the ink set are aqueous, the ink aggregation liquid preferably contains a water-soluble organic solvent as an organic solvent. Specific examples of the water-soluble organic solvent contained in the ink aggregation liquid include those exemplified as the water-soluble organic solvents that can be contained in the non-white color ink, for example. A single water-soluble organic solvent may be used alone, or a combination of two or more water-soluble organic solvents may be used.

The amount of the water-soluble organic solvent in the ink aggregation liquid may be 1% by mass or more, 5% by mass or more, or 10% by mass or more, for example. Further, the amount of the water-soluble organic solvent in the ink aggregation liquid may be 50% by mass or less, 40% by mass or less, or 30% by mass or less. The amount of the water-soluble organic solvent in the non-white color ink may be in a range from 1 to 50% by mass, for example.

The ink aggregation liquid may contain water. Examples of the water include ion-exchanged water, distilled water, ultrapure water, and the like. The amount of the water in the ink aggregation liquid may be in a range from 10 to 90% by mass, for example.

It is preferable that the ink aggregation liquid contains a surfactant. Specific examples of the surfactant contained in the ink aggregation liquid include those exemplified as the surfactants that can be contained in the non-white color ink, for example. The amount of the surfactant in the white ink may be in a range from 0.01 to 10% by mass, relative to the total amount of the ink aggregation liquid, for example.

A method used for producing the ink aggregation liquid is not particularly limited. The ink aggregation liquid can be obtained by using a stirring device such as a three-one motor to disperse all of components, either in a single batch or in a number of separate batches, and then passing the resulting dispersion through a filtration device such as a membrane filter if desired, for example.

A thermal transfer sheet can be produced by performing a method for applying each ink and the ink aggregation liquid of the ink set of an embodiment on a substrate sheet, for example.

The type of the substrate sheet is not particularly limited, and it is sufficient if printing using the ink set of an embodiment is possible, the substrate sheet has resistance to pressure and temperature conditions during thermal transfer, and the substrate sheet can be peeled off after transfer, for example. Further, an ink absorbing layer, an easily peeled layer, or the like may be disposed on a print surface of the substrate sheet. As a specific example of the substrate sheet, a substrate sheet generally used as a substrate sheet for DTF printing can be widely used.

Examples of the application order of each ink and the ink aggregation liquid in the ink set include the order in which the non-white color ink is applied, then the ink aggregation liquid is applied, and then the white or transparent ink is applied, the order in which the ink aggregation liquid is applied, then the non-white color ink is applied, and then the white or transparent ink is applied, and the order in which the non-white color ink is applied, then the white ink is applied, and then the ink aggregation liquid is applied. From thereamong, the order in which the non-white color ink is applied, then the ink aggregation liquid is applied, and then the white or transparent ink is applied, or the order in which the ink aggregation liquid is applied, then the non-white color ink is applied, and then the white or transparent ink is applied is preferable, because a thermal transfer sheet with excellent image reproduction characteristics can be obtained.

When the order in which the non-white color ink is applied, then the ink aggregation liquid is applied, and then the white or transparent ink is applied is adopted, the dot size of the non-white color ink tends to be large. Therefore, even when printing is performed at a low resolution, solid filling becomes favorable, and image density tends to be high. Meanwhile, when the order in which the ink aggregation liquid is applied, then the non-white color ink is applied, and then the white or transparent ink is applied is adopted, since the dot size of the non-white color ink tends to be small, even when printing is performed at a high resolution, small characters and fine lines are not easily broken and a sharp image can be easily obtained.

When each ink and the ink aggregation liquid are applied on the substrate sheet, drying steps may be performed after applying each ink and the ink aggregation liquid, or each ink and the ink aggregation liquid may be continuously applied by what is referred to as a wet-on-wet method without performing the drying steps. Even when each ink and the ink aggregation liquid of the ink set of an embodiment are applied by means of the wet-on-wet method, color mixing is less likely to occur and a thermal transfer sheet with excellent image reproduction characteristics can be obtained.

Suppose that each ink and the ink aggregation liquid are applied by means of the wet-on-wet method. In the above case, the residual amount of a volatile fraction in each ink or an ink aggregation liquid which has been previously applied at the time of subsequent application of each ink or an ink aggregation liquid may be 50% by mass or more, 75% by mass or more, or 90% by mass or more, for example. The time interval for applying each ink and the ink aggregation liquid is preferably in a range from 0.1 to 200 seconds.

A method for producing a thermal transfer sheet of an embodiment (hereinafter sometimes referred to as “production method 1”) includes applying the non-white color ink, the ink aggregation liquid, and at least one selected from the group consisting the white ink and the transparent ink on the substrate sheet in order by means of the wet-on-wet method.

Further, a method for producing a thermal transfer sheet of another embodiment (hereinafter sometimes referred to as “production method 2”) includes applying the ink aggregation liquid, the non-white color ink, and at least one selected from the group consisting the white ink and the transparent ink on the substrate sheet in order by means of the wet-on-wet method.

There are no particular limitations on the method for applying each ink and the ink aggregation liquid on the substrate sheet, and each ink and the ink aggregation liquid can be applied by means of various printing methods such as screen printing, roller printing, and inkjet printing. In an embodiment, each ink and the ink aggregation liquid may be applied by means of inkjet printing, from the viewpoints that a thermal transfer sheet can be efficiently produced, and the amount applied of each component can be easily controlled. There are no particular limitations on the type of an inkjet method, and any of a piezo method, an electrostatic method, and a thermal method may be used. Each ink and the ink aggregation liquid can be applied by means of the inkjet method by jetting liquid droplets from an inkjet head based on a digital signal using a general inkjet printer, with the jetted ink droplets being adhered to the fabric.

The amount applied of each ink and the ink aggregation liquid can be appropriately adjusted according to the type of the substrate sheet, the design of a print image, and the like. Basically, the amount applied of each ink and the ink aggregation liquid is not affected by the application order of each ink and the ink aggregation liquid. The amount applied of each ink and the ink aggregation liquid can be the same in both of the production method 1 and production method 2.

The amount applied of the non-white color ink can be appropriately adjusted according to the type of the substrate sheet, the design of a print image, and the like. The amount applied of the non-white color ink may be in a range from 5 to 50 g/m², for example.

The amount applied of the ink aggregation liquid can be appropriately adjusted according to the type of the substrate sheet, the design of a print image, and the like. The amount applied of the ink aggregation liquid may be in a range from 0.5 to 30 g/m², for example. In the method for producing a thermal transfer sheet of an embodiment, the amount applied of the ink aggregation liquid is preferably 20 g/m² or less, and more preferably 15 g/m² or less, in order to reduce the tackiness of the thermal transfer sheet and facilitate handling thereof. Further, since image cracking in the thermal transfer sheet is less likely to occur, it is particularly preferable that the amount applied of the ink aggregation liquid is 10 g/m² or less.

The amount applied of the white/transparent ink can be appropriately adjusted according to the type of the substrate sheet, the design of a print image, and the like. Regarding the amount applied of the white/transparent ink, the total application amount of both the white ink and the transparent ink may be in a range from 5 to 300 g/m², for example. Further, to achieve a thermal transfer sheet with high transferability regardless of the type of a print medium and to make it difficult to cause roughness even when a print medium is the fabric, when the powder is applied, the amount applied of the white/transparent ink is preferably in a range from 5 to 200 g/m² and more preferably in a range from 10 to 150 g/m². When the powder is not applied, the amount applied of the white/transparent ink is preferably in a range from 50 to 300 g/m², and more preferably in a range from 75 to 250 g/m².

The ratio of the amount applied of the ink aggregation liquid per unit area to the total amount applied of the white ink and the transparent ink per unit area (hereinafter sometimes referred to as “X value”) may be 0.6 or less. In the method for producing a thermal transfer sheet of an embodiment, in order to reduce the tackiness of the thermal transfer sheet and facilitate handling thereof, the X value is preferably 0.3 or less. The X value may be in a range from 0.01 to 0.3, for example.

The production method 1 and production method 2 may include applying powder. The powder is preferably applied after applying each ink and the ink aggregation liquid. As a more preferred aspect of an embodiment, if at least one selected from the group consisting the non-white color ink, the white ink, the transparent ink and the ink aggregation liquid contains a high boiling point solvent, the powder adhesiveness is further enhanced. Even in this case, since the fluidity of the white ink or the transparent ink is decreased by the ink aggregation liquid comprised in the ink set of an embodiment, the powder does not absorb too much ink.

The type of the powder is not particularly limited, and examples of the powder include hot melt powder, foaming powder, and the like. By using the hot melt powder as the powder, the robustness of a transfer article becomes further favorable. The type of the hot melt powder is not particularly limited. It is possible to use various resin powder which is solid (powder) at normal temperature and which can be melted by being heated at about a temperature in a range from 90 to 160° C., for example. The particle size of the hot melt powder is not particularly limited, but the average particle size may be in a range from 100 to 300 μm, for example. As a specific example of the hot melt powder, hot melt powder generally used as hot melt powder for DTF printing can be widely used.

The powder is preferably applied before a portion where each ink and the ink aggregation liquid are applied is dried. The residual amount of a volatile fraction of the portion where each ink and the ink aggregation liquid are applied at the time of powder application may be 50% by mass or more, 75% by mass or more, or 90% by mass or more, for example. The time interval from the end of application of all inks and the ink aggregation liquid to application of the hot melt powder is preferably 0.1 to 200 seconds.

The amount applied of the powder is not particularly limited, but may be in a range from 10 to 200 g/m², or in a range from 20 to 100 g/m², for example. It is preferable to apply the powder uniformly and evenly to the portion where each ink and the ink aggregation liquid are applied so as not to cause image lack during transfer. The powder can be applied by means of a method of dispersing an excess amount of powder on the portion where each ink and the ink aggregation liquid are applied to apply the required amount of powder, and then removing excess powder.

A method for removing the excess powder is not particularly limited, and examples of the method include a method for brushing off the excess powder by vibration or a method for dispersing the excess powder by generating an air current with an airbrush or the like.

When the hot melt powder is used as the powder, the hot melt powder may be melted by heating after being applied, or a thermal transfer sheet may be obtained by not melting the hot melt powder and using the hot melt powder without any changes. When the powder is melted, a heating temperature and heating time may be appropriately adjusted according to a melting point of the hot melt powder. However, the powder may be heated for about 0.5 to 10 minutes at about a temperature in a range from 90 to 160° C., for example. After heating, a cooling step may be performed. Examples of a cooling method include air cooling and cooling by a cooler.

In a method for producing a transfer printed matter of an embodiment, the thermal transfer sheet obtained by means of the production method of an embodiment is superposed on a print medium, they are heated to transfer an image, and then a substrate sheet is peeled off.

The print medium is not particularly limited as long as the print medium enables thermal transfer using a pressing machine or the like. Examples of the print medium include a fabric and vinyl sheet. The fabric is not particularly limited, and a wide variety of fabrics can be used for the fabric. Examples of fibers constituting the fabric include natural fibers such as cotton, silk, wool and linen; chemical fibers such as polyester, acrylic, polyurethane, nylon, rayon, cupra, and acetate; or mixtures of these fibers. Further, examples of the fabric include a woven fabric, a knitted fabric, or a nonwoven fabric.

Conditions such as pressure, temperature, and pressing time at the time of transfer are appropriately adjusted according to the type of a print medium and the type of hot melt powder. When a heat press manufactured by FUSION is used, a pressure condition may be in a range from 3 to 9 pr, a temperature condition may be in a range from 90 to 160° C., and the pressing time may be in a range from 5 to 30 seconds, for example.

After transferring an image, it is preferable to cool a transfer printed matter to a normal temperature and then peel off a substrate sheet.

One or more embodiments of the present disclosure will be described below.

<1> An ink set for a thermal transfer sheet including: a color ink having a color other than white; at least one selected from the group consisting of a white ink and a transparent ink; and an ink aggregation liquid.

<2> The ink set for a thermal transfer sheet according to <1>, wherein (1) the color ink having a color other than white contains an organic solvent having a boiling point of 260° C. or higher, (2) the at least one of the white ink and the transparent ink contains an organic solvent having a boiling point of 260° C. or higher, or (3) both the above (1) and the above (2) are satisfied.

<3> A method for producing a thermal transfer sheet including: applying a color ink having a color other than white, an ink aggregation liquid, and at least one of a white ink and a transparent ink on a surface of a substrate sheet in order by a wet-on-wet method.

<4> The method for producing a thermal transfer sheet according to <3>, wherein (1) the color ink having a color other than white contains an organic solvent having a boiling point of 260° C. or higher, (2) the at least one of the white ink and the transparent ink contains an organic solvent having a boiling point of 260° C. or higher, or (3) both the above (1) and the above (2) are satisfied.

<5> The method for producing a thermal transfer sheet according to <3> or <4>, wherein the ratio of the amount applied of the ink aggregation liquid per unit area to the total amount applied of the white ink and the transparent ink per unit area is 0.3 or less.

<6> The method for producing a thermal transfer sheet according to any one of <3> to <5>, wherein the amount applied of the ink aggregation liquid per unit area is 10 g/m² or less.

<7> The method for producing a thermal transfer sheet according to any one of <3> to <6>, comprising: applying hot melt powder on the substrate after applying the color ink having a color other than white, the ink aggregation liquid, and at least one selected from the group consisting of the white ink and the transparent ink on the substrate sheet in order by the wet-on-wet method.

<8> A method for producing a transfer printed matter comprising: producing a thermal transfer sheet by performing the method for producing a thermal transfer sheet according to any one of <3> to <7>; superposing the thermal transfer sheet on a print medium and heating the superposed the thermal transfer sheet on the print medium to transfer an image onto the print medium; and peeling off a substrate sheet from the thermal transfer sheet on the print medium.

<9> A method for producing a thermal transfer sheet comprising: applying an ink aggregation liquid, a color ink having a color other than white, and at least one selected from the group consisting of a white ink and a transparent ink on a substrate sheet in order by a wet-on-wet method.

<10> The method for producing a thermal transfer sheet according to <9>, wherein (1) the color ink having a color other than white contains an organic solvent having a boiling point of 260° C. or higher, (2) the at least one of the white ink and the transparent ink contains an organic solvent having a boiling point of 260° C. or higher, or (3) both the above (1) and the above (2) are satisfied.

<11> The method for producing a thermal transfer sheet according to <9> or <10>, wherein the ratio of the amount applied of the ink aggregation liquid per unit area to the total amount applied of the white ink and the transparent ink per unit area is 0.3 or less.

<12> The method for producing a thermal transfer sheet according to any one of <9> to <11>, the amount applied of the ink aggregation liquid per unit area is 10 g/m² or less.

<13> The method for producing a thermal transfer sheet according to any one of <9> to <12>, applying hot melt powder on the substrate after applying the ink aggregation liquid, the color ink having a color other than white, and at least one selected from the group consisting of the white ink and the transparent ink on the substrate sheet in order by the wet-on-wet method.

<14> A method for producing a transfer printed matter comprising:
producing a thermal transfer sheet by performing the method for producing a thermal transfer sheet according to any one of <9> to <13>; superposing the thermal transfer sheet on a print medium and heating the superposed the thermal transfer sheet on the print medium to transfer an image onto the print medium; and peeling off a substrate sheet from the thermal transfer sheet on the print medium.

### EXAMPLES

Embodiments of the present disclosure will be described below in further detail by using examples. The present disclosure is not limited to the examples below. In the following descriptions, “%” represents “% by mass” unless specifically stated otherwise. The amounts shown in each table indicate the total amounts of raw materials blended in the form of a solution, dispersion, or the like.

### [Production of Ink Set for Thermal Transfer Sheet]

Non-white color inks 1 to 4, white ink 1, and ink aggregation liquid 1 were produced in the following manner, and these were used for an ink set for a thermal transfer sheet.

### [Production of Non-White Color Inks]

The raw materials were mixed at the blending ratio shown in Table 1, and the obtained mixture was filtered by using a cellulose acetate membrane filter having a pore size of 3 μm. Accordingly, the non-white color inks 1 to 4 were obtained.

TABLE 1

| | | Non-white | Non-white | Non-white | Non-white |
|---|---|---|---|---|---|
| | | ink 1 | ink 2 | ink 3 | ink 4 |
| Non-white pigment dispersion 1 | [parts by mass] | 20.0 | | | |
| (pigment fraction: 15% by mass) | | | | | |
| Non-white pigment dispersion 2 | [parts by mass] | | 30.0 | | |
| (pigment fraction: 10% by mass) | | | | | |
| Non-white pigment dispersion 3 | [parts by mass] | | | 30.0 | |
| (pigment fraction: 10% by mass) | | | | | |
| Non-white pigment dispersion 4 | [parts by mass] | | | | 30.0 |
| (pigment fraction: 10% by mass) | | | | | |
| Resin emulsion 1 | [parts by mass] | 26.3 | 26.3 | 26.3 | 26.3 |
| (resin fraction: 38% by mass) | | | | | |
| Glycerol | [parts by mass] | 10.0 | 10.0 | 10.0 | 10.0 |
| Diethylene glycol | [parts by mass] | 20.0 | 20.0 | 20.0 | 20.0 |
| Surfactant | [parts by mass] | 0.5 | 0.5 | 0.5 | 0.5 |
| Ion-exchanged water | [parts by mass] | 23.2 | 13.2 | 13.2 | 13.2 |
| Total | [parts by mass] | 100.0 | 100.0 | 100.0 | 100.0 |

Details of the raw materials shown in Table 1 are as follows.
Non-white pigment dispersion 1: “CAB-O-JET 300” manufactured by Cabot Corporation, black pigment dispersion, solid fraction: 15% by mass
Non-white pigment dispersion 2: “CAB-O-JET 250C” manufactured by Cabot Corporation, cyan pigment dispersion, solid fraction: 10% by mass
Non-white pigment dispersion 3: “CAB-O-JET 260M” manufactured by Cabot Corporation, magenta pigment dispersion, solid fraction: 10% by mass
Non-white pigment dispersion 4: “CAB-O-JET 270Y” manufactured by Cabot Corporation, yellow pigment dispersion, solid fraction: 10% by mass
Resin emulsion 1: “Mowinyl 6775” manufactured by Japan Coating Resin Corporation, urethane resin, solid fraction: 38% by mass
Glycerol: a water-soluble organic solvent having a boiling point of 290° C., manufactured by FUJIFILM Wako Pure Chemical Corporation
Diethylene glycol: a water-soluble organic solvent having a boiling point of 246° C., manufactured by FUJIFILM Wako Pure Chemical Corporation
Surfactant: “OLFINE E1010” manufactured by Nissin Chemical Industry Co., Ltd., an acetylene-based surfactant

### [Production of White Ink]

The raw materials were mixed at the blending ratio shown in Table 2, and the obtained mixture was filtered by using a cellulose acetate membrane filter having a pore size of 3 μm. Accordingly, the white ink 1 was obtained.

TABLE 2

| | | White ink 1 |
|---|---|---|
| White pigment dispersion 1 | [parts by mass] | 28.6 |
| (pigment fraction: 35% by mass) | | |
| Resin emulsion 2 | [parts by mass] | 25.0 |
| (resin fraction: 40% by mass) | | |
| Resin emulsion 3 | [parts by mass] | 15.6 |
| (resin fraction: 32% by mass) | | |
| Glycerol | [parts by mass] | 20.0 |
| Surfactant | [parts by mass] | 1.0 |
| Ion-exchanged water | [parts by mass] | 9.8 |
| Total | [parts by mass] | 100.0 |

Details of the raw materials shown in Table 2 are as follows.
White pigment dispersion 1:350 g of titanium oxide (“R62N” manufactured by SAKAI CHEMICAL INDUSTRY CO., LTD.) as a white pigment, and 14 g (active component: 3.5 g) of a pigment dispersant (“DEMOL EP” manufactured by Kao Corporation) were mixed with 636 g of ion-exchanged water, and a beads mill (“DYNO-MILL KDL model A” manufactured by Shinmaru Enterprises Corporation) containing 0.5 mmø zirconia beads at a fill ratio of 80% was used to disperse the mixture under conditions including a residence time of 2 minutes. Accordingly, a white pigment dispersion (pigment fraction: 35% by mass) was obtained.
Resin emulsion 2: “SUPERFLEX 740” manufactured by DKS Co. Ltd., an urethane resin, resin fraction: 40% by mass
Resin emulsion 3: “SUPERFLEX 420” manufactured by DKS Co. Ltd., an urethane resin, resin fraction: 32% by mass
Glycerol: a water-soluble organic solvent having a boiling point of 290° C., manufactured by FUJIFILM Wako Pure Chemical Corporation
Surfactant: “OLFINE E1010” manufactured by Nissin Chemical Industry Co., Ltd., an acetylene-based surfactant

### [Production of Ink Aggregation Liquid]

The raw materials were mixed at the blending ratio shown in Table 2, and the obtained mixture was filtered by using a cellulose acetate membrane filter having a pore size of 3 μm. Accordingly, the ink aggregation liquid 1 was obtained.

TABLE 3

| | | Ink aggregation |
|---|---|---|
| | | liquid 1 |
| Calcium chloride | [parts by mass] | 30.0 |
| Diethylene glycol | [parts by mass] | 15.0 |
| Glycerol | [parts by mass] | 5.0 |
| Surfactant | [parts by mass] | 0.8 |
| Ion-exchanged water | [parts by mass] | 49.2 |
| Total | [parts by mass] | 100.0 |

Details of the raw materials shown in Table 3 are as follows.
Calcium chloride: manufactured by FUJIFILM Wako Pure Chemical Corporation
Diethylene glycol: a water-soluble organic solvent having a boiling point of 246° C., manufactured by FUJIFILM Wako Pure Chemical Corporation
Glycerol: a water-soluble organic solvent having a boiling point of 290° C., manufactured by FUJIFILM Wako Pure Chemical Corporation
Surfactant: “OLFINE E1010” manufactured by Nissin Chemical Industry Co., Ltd., an acetylene-based surfactant

### Examples 1 to 14 and Comparative Example 1

Using the non-white color inks 1 to 4, white ink 1, and ink aggregation liquid 1 which have been previously obtained as components of the ink set for a thermal transfer sheet, a thermal transfer sheet and a transfer printed matter were produced by means of the following procedure. The obtained thermal transfer sheet and transfer printed matter were evaluated by the following procedure. Tables 4 to 6 show results.

### [Production of Thermal Transfer Sheet]

According to steps 1 to 3 in Tables 4 to 6, the non-white color inks 1 to 4, white ink 1, and ink aggregation liquid 1 were applied on a substrate sheet (*1) by means of a wet-on-wet method. The inks and ink aggregation liquid were applied by inkjet printing using an inkjet printer manufactured by Mastermind. The non-white color inks 1 to 4 were applied as full-color image printing, and the white ink 1 and ink aggregation liquid 1 were applied as solid image printing. The non-white color inks 1 to 4 were not applied to a portion of a print image used, and the print image had a solid image portion of the white ink 1 (hereinafter sometimes referred to as “white solid image”).

In Examples 1 to 12 and Comparative Example 1, after inks and an ink aggregation liquid were applied on a substrate sheet, hot melt powder (*2) was adhered, and excess powder was brushed off. Next, they were left in a thermostatic bath at 130° C. for 5 minutes, and the hot melt powder was melted to obtain a thermal transfer sheet.

In Examples 13 and 14, after applying inks and an ink aggregation liquid on a substrate sheet, they were left in a thermostatic bath at 130° C. for 5 minutes, and a thermal transfer sheet was obtained.
Substrate sheet (*1): premium film for DTF printing manufactured by TOYO corporation
Hot melt powder (*2): “ARTJET POWDER” manufactured by MATSUI SHIKISO CHEMICAL co., ltd.

### [Production of Transfer Printed Matter]

The thermal transfer sheet obtained above was layered on a black cotton T-shirt (*3) such that an ink adhering surface or a hot melt powder adhering surface of the transfer sheet was in contact with the T-shirt. They were heat pressed using Hotronix Fusion Heat Press (manufactured by Stahls Hotronix Inc.) under conditions where pressure setting was 9 pr, the temperature was 140° C., and the time was 20 seconds. After cooling them to normal temperature, a substrate sheet was peeled off to obtain a transfer printed matter.
Black cotton T-shirt (*3): “Printstar” manufactured by TOMS CO., LTD.

### [Evaluation of Color Mixing of Thermal Transfer Sheet]

The thermal transfer sheet was visually observed from the ink adhering surface side or the hot melt powder adhering surface side, and an evaluation was made based on the criteria below.
A: There is no color mixing between the non-white color inks 1 to 4 and the white ink 1, and image reproduction characteristics are excellent.
B: There is a color mixing between the non-white color inks 1 to 4 and the white ink 1 in a part of an image, but there is no significant deterioration in image reproduction characteristics.
C: There is a color mixing between the non-white color inks 1 to 4 and the white ink 1 in a part or an entirety of an image, and image reproduction characteristics are poor.

### [Evaluation of Cracking of Thermal Transfer Sheet]

The thermal transfer sheet was visually observed from the ink adhering surface side or the hot melt powder adhering surface side, and an evaluation was made based on the criteria below.
A: There is no cracking in an image, and image reproduction characteristics are excellent.
B: There is cracking in a part of an image, but there is no significant deterioration in image reproduction characteristics.
C: There is cracking in a part or an entirety of an image, and image reproduction characteristics are poor.

### [Evaluation of Tackiness of Thermal Transfer Sheet]

A user touched the ink adhering surface or hot melt powder adhering surface of the thermal transfer sheet with a finger, and evaluated the tackiness based on the criteria below.
A: There is no material adhering to a finger, and even if these is, the amount thereof is very small.
B: There is a material adhering to a finger, but the amount of the adhering material is small.
C: There is a material adhering to a finger, and the amount of the adhering material is large.

### [Evaluation of Uniformity of White Solid Image of Transfer Printed Matter]

The white solid image of the transfer printed matter was visually observed, and an evaluation was made based on the criteria below.
A: There are no irregularities in the white solid image, and the uniformity is high.
B: There are irregularities in the white solid image, but not to the extent that the fabric color becomes transparent.
C: There are irregularities in the white solid image, and the fabric color is partially transparent.

### [Evaluation of Image Lack in Transfer Printed Matter]

An image of a transfer printed matter was visually observed to check whether there is an image lack.

TABLE 4

| | | Example 1 | Example 2 | Example 3 | Example 4 | Example 5 |
|---|---|---|---|---|---|---|
| Step 1 | Type | Non-white | Non-white | Non-white | Non-white | Non-white |
| | | ink 1-4 | ink 1-4 | ink 1-4 | ink 1-4 | ink 1-4 |
| | Application amount | Each 24 | Each 24 | Each 24 | Each 24 | Each 24 |
| | [g/m²] | | | | | |
| Step 2 | Type | Ink | Ink | Ink | Ink | Ink |
| | | aggregation | aggregation | aggregation | aggregation | aggregation |
| | | liquid 1 | liquid 1 | liquid 1 | liquid 1 | liquid 1 |
| | Application amount | 3 | 1.5 | 3 | 1.5 | 6 |
| | [g/m²] | | | | | |
| Step 3 | Type | White | White | White | White | White |
| | | ink 1 | ink 1 | ink 1 | ink 1 | ink 1 |
| | Application amount | 48 | 48 | 96 | 96 | 48 |
| | [g/m²] | | | | | |
| X value (*4) | | 0.06 | 0.03 | 0.03 | 0.02 | 0.13 |
| Evaluation | Evaluation of color mixing | A | A | A | A | A |
| of thermal | Evaluation of cracking | A | A | A | A | A |
| transfer | Evaluation of tackiness | A | A | B | B | A |
| sheet | | | | | | |
| Evaluation | Uniformity of white | A | A | A | A | A |
| of transfer | solid image | | | | | |
| printed | Presence or absence | Absent | Absent | Absent | Absent | Absent |
| matter | of image lack | | | | | |

TABLE 5

| | | Example 6 | Example 7 | Example 8 | Example 9 | Example 10 |
|---|---|---|---|---|---|---|
| Step 1 | Type | Non-white | Non-white | Non-white | Non-white | Non-white |
| | | ink 1-4 | ink 1-4 | ink 1-4 | ink 1-4 | ink 1-4 |
| | Application amount | Each 24 | Each 24 | Each 24 | Each 24 | Each 24 |
| | [g/m²] | | | | | |
| Step 2 | Type | Ink | Ink | Ink | Ink | Ink |
| | | aggregation | aggregation | aggregation | aggregation | aggregation |
| | | liquid 1 | liquid 1 | liquid 1 | liquid 1 | liquid 1 |
| | Application amount | 3 | 3 | 3 | 24 | 12 |
| | [g/m²] | | | | | |
| Step 3 | Type | White | White | White | White | White |
| | | ink 1 | ink 1 | ink 1 | ink 1 | ink 1 |
| | Application amount | 12 | 48 | 48 | 48 | 48 |
| | [g/m²] | | | | | |
| X value (*4) | | 0.25 | 0.06 | 0.06 | 0.50 | 0.25 |
| Evaluation | Evaluation of color mixing | A | A | A | A | A |
| of thermal | Evaluation of cracking | A | A | A | B | B |
| transfer | Evaluation of tackiness | A | A | A | B | A |
| sheet | | | | | | |
| Evaluation | Uniformity of white | A | A | A | A | A |
| of transfer | solid image | | | | | |
| printed | Presence or absence | Absent | Absent | Absent | Absent | Absent |
| matter | of image lack | | | | | |

TABLE 6

| | | | | | | Comparative |
|---|---|---|---|---|---|---|
| | | Example 11 | Example 12 | Example 13 | Example 14 | Example 1 |
| Step 1 | Type | Ink | Non-white | Non-white | Ink | Non-white |
| | | aggregation | ink 1-4 | ink 1-4 | aggregation | ink 1-4 |
| | | liquid 1 | | | liquid 1 | |
| | Application amount | 3 | Each 24 | Each 24 | 3 | Each 24 |
| | [g/m²] | | | | | |
| Step 2 | Type | Non-white | White | Ink | Non-white | White |
| | | ink 1-4 | ink 1 | aggregation | ink 1-4 | ink 1 |
| | | | | liquid 1 | | |
| | Application amount | Each 24 | 48 | 3 | Each 24 | 48 |
| | [g/m²] | | | | | |
| Step 3 | Type | White | Ink | White | White | — |
| | | ink 1 | aggregation | ink 1 | ink 1 | |
| | | | liquid 1 | | | |
| | Application amount | 48 | 3 | 150 | 150 | — |
| | [g/m²] | | | | | |
| X value (*4) | | 0.06 | 0.06 | 0.02 | 0.02 | — |
| Evaluation | Evaluation of color mixing | A | B | A | A | C |
| of thermal | Evaluation of cracking | A | A | A | A | A |
| transfer | Evaluation of tackiness | A | A | B | B | A |
| sheet | | | | | | |
| Evaluation | Uniformity of white | A | A | A | A | C |
| of transfer | solid image | | | | | |
| printed | Presence or absence | Absent | Absent | Absent | Absent | Absent |
| matter | of image lack | | | | | |

Each X value (*4) in Tables 4 to 6 is (amount applied of ink aggregation liquid per unit area)/(total amount applied of white ink and transparent ink per unit area).

Examples 1 to 14 used the ink set for a thermal transfer sheet including the non-white color inks 1 to 4, white ink 1, and ink aggregation liquid 1. In Examples 1 to 14, both of thermal transfer sheets and transfer printed matters had excellent image reproduction characteristics. Further, in Examples 1 to 14, no image lack was observed in the transfer printed matters. In particular, in Examples 1 to 8 and 10 to 14 in which each X value was 0.2 or less, no cracking was observed in transfer sheets and image reproduction characteristics were high.

In Comparative Example 1 which did not use the ink aggregation liquid 1, color mixing was observed in a thermal transfer sheet, and the uniformity of a white solid image in a transfer printed matter was low due to irregularities caused by hot melt powder absorbing a white ink.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An ink set for a thermal transfer sheet comprising:
a color ink having a color other than white;
at least one selected from the group consisting of a white ink and a transparent ink; and
an ink aggregation liquid.

2. The ink set for a thermal transfer sheet according to claim 1, wherein
(1) the color ink having a color other than white contains an organic solvent having a boiling point of 260° C. or higher,
(2) the at least one of the white ink and the transparent ink contains an organic solvent having a boiling point of 260° C. or higher, or
(3) both the above (1) and the above (2) are satisfied.

3. A method for producing a thermal transfer sheet comprising:
applying a color ink having a color other than white, an ink aggregation liquid, and at least one selected from the group consisting of a white ink and a transparent ink on a substrate sheet in order by a wet-on-wet method.

4. The method for producing a thermal transfer sheet according to claim 3, wherein
(1) the color ink having a color other than white contains an organic solvent having a boiling point of 260° C. or higher,
(2) the at least one of the white ink and the transparent ink contains an organic solvent having a boiling point of 260° C. or higher, or
(3) both the above (1) and the above (2) are satisfied.

5. The method for producing a thermal transfer sheet according to claim 3, wherein
the ratio of the amount applied of the ink aggregation liquid per unit area to the total amount applied of the white ink and the transparent ink per unit area is 0.3 or less.

6. The method for producing a thermal transfer sheet according to claim 3, wherein
the amount applied of the ink aggregation liquid per unit area is 10 g/m² or less.

7. The method for producing a thermal transfer sheet according to claim 3 comprising:
applying hot melt powder on the substrate sheet after applying the color ink having a color other than white, the ink aggregation liquid, and at least one selected from the group consisting of the white ink and the transparent ink on the substrate sheet in order by the wet-on-wet method.

8. A method for producing a transfer printed matter comprising:
producing a thermal transfer sheet by performing the method for producing a thermal transfer sheet according to claim 3;
superposing the thermal transfer sheet on a print medium and heating the thermal transfer sheet superposed on the print medium to transfer an image onto the print medium; and
peeling off a substrate sheet from the thermal transfer sheet on the print medium.

9. A method for producing a thermal transfer sheet comprising:
applying an ink aggregation liquid, a color ink having a color other than white, and at least one selected from the group consisting of a white ink and a transparent ink on a substrate sheet in order by a wet-on-wet method.

10. The method for producing a thermal transfer sheet according to claim 9, wherein
(1) the color ink having a color other than white contains an organic solvent having a boiling point of 260° C. or higher,
(2) the at least one of the white ink and the transparent ink contains an organic solvent having a boiling point of 260° C. or higher, or
(3) both the above (1) and the above (2) are satisfied.

11. The method for producing a thermal transfer sheet according to claim 9, wherein
the ratio of the amount applied of the ink aggregation liquid per unit area to the total amount applied of the white ink and the transparent ink per unit area is 0.3 or less.

12. The method for producing a thermal transfer sheet according to claim 9, wherein
the amount applied of the ink aggregation liquid per unit area is 10 g/m² or less.

13. The method for producing a thermal transfer sheet according to claim 9 comprising:
applying hot melt powder on the substrate sheet after applying the ink aggregation liquid, the color ink having a color other than white, and at least one selected from the group consisting of the white ink and the transparent ink on the substrate sheet in order by the wet-on-wet method.

14. A method for producing a transfer printed matter comprising:
producing a thermal transfer sheet by performing the method for producing a thermal transfer sheet according to claim 9;
superposing the thermal transfer sheet on a print medium and heating the thermal transfer sheet superposed on the print medium to transfer an image onto the print medium; and
peeling off a substrate sheet from the thermal transfer sheet on the print medium.
